(19) United States
(12) Patent Application Publication
(10) Pub. No.: US 2008/0195376 A1
(43) Pub. Date: Aug. 14, 2008

(54) Conceptual communication via real-time translation on portable electronic devices

(76) Inventors: Jon Vincent Ramer, San Pedro, CA (US); Kevin Soule Murray, Kingwood, TX (US)

Correspondence Address: Mr. Jon V. Ramer, 3171 North Gaffey Street, San Pedro, CA, 90731, US

(21) Appl. No.: 11/705,646

(22) Filed: Feb. 14, 2007

(51) Int. Cl. G06F 17/28

(52) U.S. Cl. 704/5

(57) ABSTRACT

Effective communication between people that speak different languages can be easily facilitated via a portable electronic device, such as a cell phone, that has a translation program and a set of words in both languages that are selected to convey a wide range of universal concepts. Users can scroll though a set of categories and select words for immediate translation into a visual or auditory result. The carefully selected words in the translation matrix can be arranged by a user to convey almost every concept in casual conversation.

### FIELD OF THE INVENTION

This invention pertains generally to the field of portable language translation.

### BACKGROUND OF THE INVENTION

Effective on-the-spot communication between people that speak different languages can be easily facilitated via a portable electronic device, such as a cell phone, that has a translation program and a set of words in both languages that are selected to convey a wide range of universal concepts. The human brain can grasp the intent and meaning of a message even if grammar, punctuation, gender-specific prefixes, tense, or language-specific word sequencing are not conveyed, out of sequence, or grammatically incorrect. A set of 340 carefully selected words in a translation matrix can be arranged to convey almost every concept in casual conversation. Users can scroll though a set of 12 categories and select words for immediate translation into a visual or auditory result.

### SUMMARY OF THE INVENTION

A computer program written to operate on a cell phone or other portable electronic device and designed to display text or play audio files of words in multiple languages that a user can select from a carefully populated list.

### BRIEF DESCRIPTION OF DRAWINGS

FIG. 1 is a sample screen capture of the user interface for selecting a word category.

FIG. 2 is a sample screen capture of a user phrasing a multi-word sentence for translation.

FIGS. 3 and 4 are sample screen captures of the user interface for selecting which language to translate word from and to.

FIG. 5 is a sample screen capture of how a user plays the audio translation of a selected word.

Attachment 1 is a listing of the source code in Java script language for the translation program.

Attachment 2 is a listing of the selected conceptual words for the translation database.

### DETAILED DESCRIPTION OF THE INVENTION

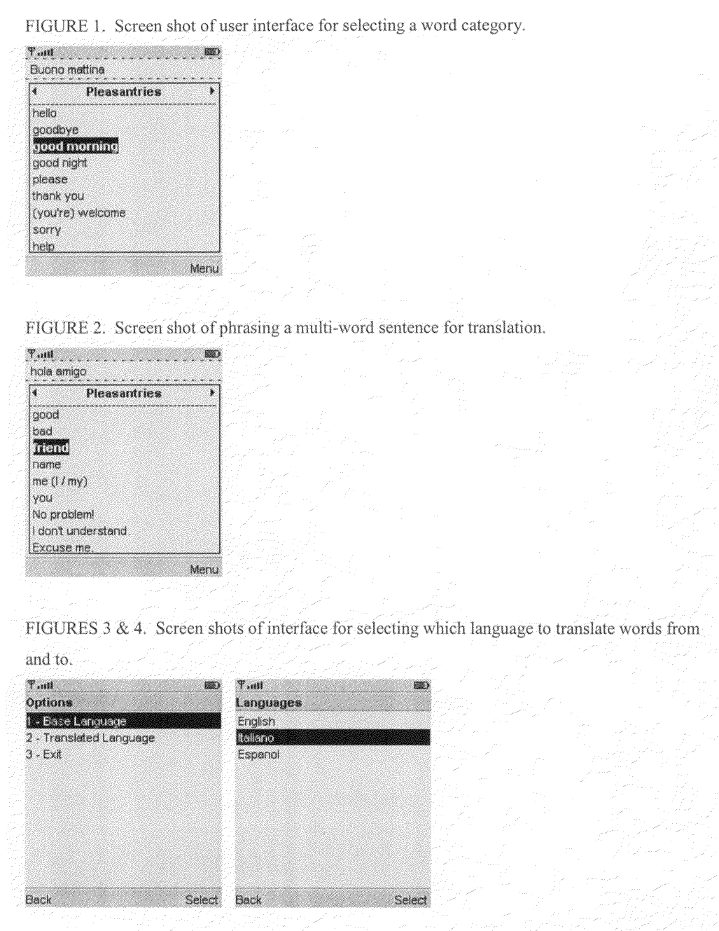

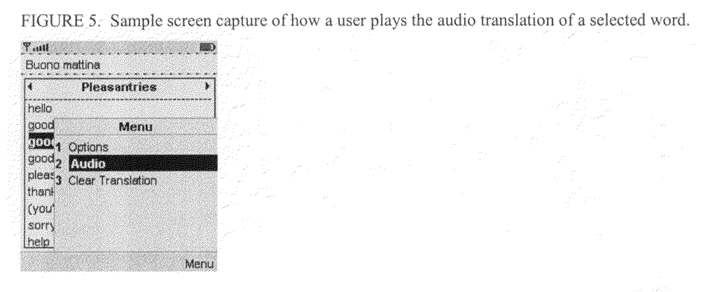

The attached computer program listing, Attachment 1, shows the source code for a translation program designed to operate on a cellular telephone or other portable electronic device that allows a user to select and translate from 340 words in 12 categories. There are three levels of complexity in the words list, Pleasantries (20 words), Basic (120 words), and Extended (200 words). These word sets are listed in Attachment 2, each list subdivided into the 12 categories of Pleasantries, Actions, Descriptors, Queries, Places, Objects, Food, People, Numbers, Colors, Travel, and Time. The program is modular and is designed to store and translate multiple languages. Additionally, more words and more categories can be added to the database. FIG. 1 shows the interface of how users select a word from a category. After downloading and installing the program and word set, a user can use the arrow keys on their cell phones or other portable electronic device to scroll left and right through the categories and up and down through the word list. Upon selecting a word to be translated, a user can select another, phrasing a sentence out word-by-word, see FIG. 2. Users may then select an “Audio” function to play the selected words as an audio file through their cell phone or other portable electronic device, see FIG. 5.

It is understood that the invention is not confined to the particular embodiments set forth herein as illustrative, but embraces all such modifications thereof as come within the scope of the above claims.

1. On-the-spot effective communication between people speaking differing languages can be achieved via a portable device with a program translating a carefully selected set of conceptual words.

2. Effective conceptual communication does not require grammar, punctuation, gender-specific prefixes, tense, or language-specific word sequencing. The human brain can grasp the intent and meaning of a message even if the above points are not conveyed, out of sequence, or grammatically incorrect.

3. A database of 340 words selected for specific conceptual meanings can convey almost any message in any language.

4. The database from claim 3 is divided into 12 conceptual categories, Pleasantries, Actions, Descriptors, Queries, Places, Objects, Food, People, Numbers, Colors, Travel, and Time.

5. A Java-based computer program can store and provide a user access to the word database from claim 3 on a portable device such as a cell phone.

6. The program from claim 5 can translate messages into either a text display the intended recipient can read, or into a set of auditory sound-bites the recipient can listen to.
